(19) United States
(12) Patent Application Publication
(10) Pub. No.: US 2023/0412009 A1
(43) Pub. Date: Dec. 21, 2023

(54) POWER RECEIVING APPARATUS, COMMUNICATION METHOD FOR POWER RECEIVING APPARATUS, AND NON-TRANSITORY COMPUTER-READABLE STORAGE MEDIUM

(71) Applicant: CANON KABUSHIKI KAISHA, Tokyo (JP)

(72) Inventor: Hidetada Nago, Hiroshima (JP)

(21) Appl. No.: 18/460,400

(22) Filed: Sep. 1, 2023

Related U.S. Application Data
(63) Continuation of application No. PCT/JP2022/007161, filed on Feb. 22, 2022.

(30) Foreign Application Priority Data
Mar. 5, 2021 (JP) 2021-035342

(51) Int. Cl. H02J 50/80; H02J 50/10; H02J 50/60; H02J 7/00; H02J 50/40

(52) U.S. Cl. CPC H02J 50/80; H02J 50/10; H02J 50/60; H02J 7/0048; H02J 50/402

(57) ABSTRACT

A power receiving apparatus wirelessly receives power from a power transmitting apparatus, and communicates with the power transmitting apparatus by load modulation of the received power. A degree of modulation of the load modulation is changed in a case where a response signal from the power transmitting apparatus in response to a specific signal is not received within a predetermined period.

### CROSS-REFERENCE TO RELATED APPLICATIONS

This application is a Continuation of International Patent Application No. PCT/JP2022/007161, filed Feb. 22, 2022, which claims the benefit of Japanese Patent Application No. 2021-035342, filed Mar. 5, 2021, both of which are hereby incorporated by reference herein in their entireties.

### TECHNICAL FIELD

The present disclosure relates to a power receiving apparatus, a method for controlling a power receiving apparatus, and a storage medium.

### BACKGROUND ART

In wireless power transmission, a load modulation method is known in which a power receiving apparatus performs amplitude modulation on transmitted power during communication between the power receiving apparatus and a power transmitting apparatus. PTL 1 discloses a method for transmitting test signals having different degrees of modulation at the start of power transmission and determining the degree of modulation to be used during power transmission.

### CITATION LIST

### Patent Literature

PTL 1 Japanese Patent Laid-Open No. 2008-8763

However, according to PTL 1, for example, due to a factor such as an object different from the power receiving apparatus being placed in a power transmission range of the power transmitting apparatus during power transmission, there is a possibility that communication will not be appropriately performed even if the determined degree of modulation is used.

### SUMMARY

An object of the present disclosure is to suppress stopping of appropriate communication during power transmission.

A power receiving apparatus according to an aspect of the present disclosure wirelessly receives power from a power transmitting apparatus, and communicates with the power transmitting apparatus by load modulation of the received power. A degree of modulation of the load modulation is changed in a case where a response signal from the power transmitting apparatus in response to a specific signal transmitted by the power receiving apparatus is not received within a period.

According to the present disclosure, it is possible to suppress stopping of appropriate communication during power transmission.

Further features of the present disclosure will become apparent from the following description of exemplary embodiments with reference to the attached drawings.

### BRIEF DESCRIPTION OF DRAWINGS

FIG. 1 is a diagram illustrating communication between a power transmitting apparatus and a power receiving apparatus.

FIG. 2 is a block diagram illustrating a configuration example of the power receiving apparatus.

FIGS. 3A and 3B are diagrams illustrating communication flows between the power transmitting apparatus and the power receiving apparatus.

FIG. 4 is a diagram illustrating a configuration example of a load modulation signal modulating unit.

FIG. 5A is a diagram illustrating power transmitting coils.

FIG. 5B is a diagram illustrating the power transmitting coils.

FIG. 5C is a diagram illustrating the power transmitting coils.

FIG. 5D is a diagram illustrating the power transmitting coils.

FIG. 6A is a diagram illustrating a load modulation signal.

FIG. 6B is a diagram illustrating the load modulation signal.

FIG. 7 is a flowchart illustrating an operation of the power receiving apparatus.

FIG. 8 is a diagram for describing phases of processing performed by the power transmitting apparatus and the power receiving apparatus.

### DESCRIPTION OF EMBODIMENTS

### First Embodiment

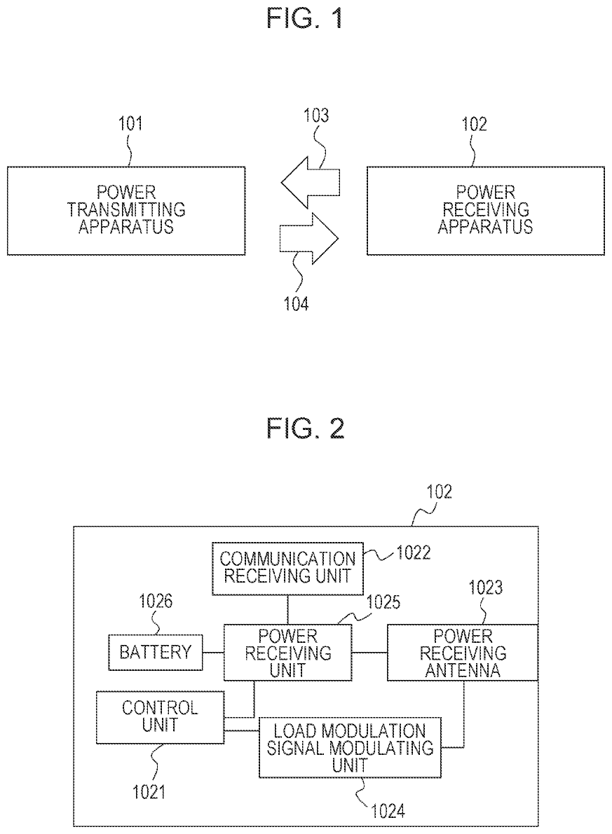

FIG. 1 is a diagram illustrating a configuration example of a power transmission system according to a first embodiment. The power transmission system includes a power transmitting apparatus 101 and a power receiving apparatus 102. The power transmitting apparatus 101 performs wireless power transmission to the power receiving apparatus 102. The wireless power transmission includes an initial phase in which authentication or the like is performed between the power transmitting apparatus 101 and the power receiving apparatus 102, and a power transmission phase in which power is transmitted. During the power transmission phase, the power receiving apparatus 102 transmits a load modulation signal 103 to the power transmitting apparatus 101.

A case where a frequency-modulated signal 104 is used for communication from the power transmitting apparatus 101 to the power receiving apparatus 102 will be described. The frequency-modulated signal 104 is used for communication from the power transmitting apparatus 101 to the power receiving apparatus 102. The load modulation signal 103 is used for communication from the power receiving apparatus 102 to the power transmitting apparatus 101. The power receiving apparatus 102 transmits the load modulation signal 103 to the power transmitting apparatus 101. The power transmitting apparatus 101 transmits the frequency-modulated signal 104 to the power receiving apparatus 102.

FIG. 2 is a block diagram illustrating a configuration example of the power receiving apparatus 102 in FIG. 1. The power receiving apparatus 102 includes a control unit 1021, a communication receiving unit 1022, a power receiving antenna 1023, a load modulation signal modulating unit 1024, a power receiving unit 1025, and a battery 1026. The power receiving apparatus 102 in FIG. 2 illustrates units related to wireless power transmission.

The control unit 1021 controls the entirety of the power receiving apparatus 102 by, for example, executing a control program stored in a memory (not illustrated). In one example, the control unit 1021 performs control necessary for device authentication and power reception in the power receiving apparatus 102. The control unit 1021 may perform control for executing an application other than wireless power transmission. The control unit 1021 includes one or more processors such as a CPU and an MPU. The control unit 1021 may include hardware that is dedicated to specific processing such as an ASIC or an array circuit such as an FPGA compiled to execute predetermined processing. The control unit 1021 causes a memory (not illustrated) to store information to be stored during execution of various kinds of processing. In addition, the control unit 1021 may measure a time using a timer.

The power receiving antenna 1023 receives power wirelessly transmitted by the power transmitting apparatus 101. The power receiving unit 1025 extracts necessary direct current power from the power received by the power receiving antenna 1023, and charges the battery 1026. The communication receiving unit 1022 extracts the frequency-modulated signal 104 including control information and state information from the power received by the power receiving antenna 1023, and outputs the frequency-modulated signal 104 to the control unit 1021. Under the control of the control unit 1021, the load modulation signal modulating unit 1024 generates the load modulation signal 103 including the control information and state information of the power receiving apparatus 102, the load modulation signal 103 being addressed to the power transmitting apparatus 101, and wirelessly transmits the load modulation signal 103 to the power transmitting apparatus 101 via the power receiving antenna 1023. After the power receiving antenna 1023 receives the power transmitted by the power transmitting apparatus 101, the load modulation signal modulating unit 1024 superimposes the load modulation signal 103 on the transmitted power by controlling a load.

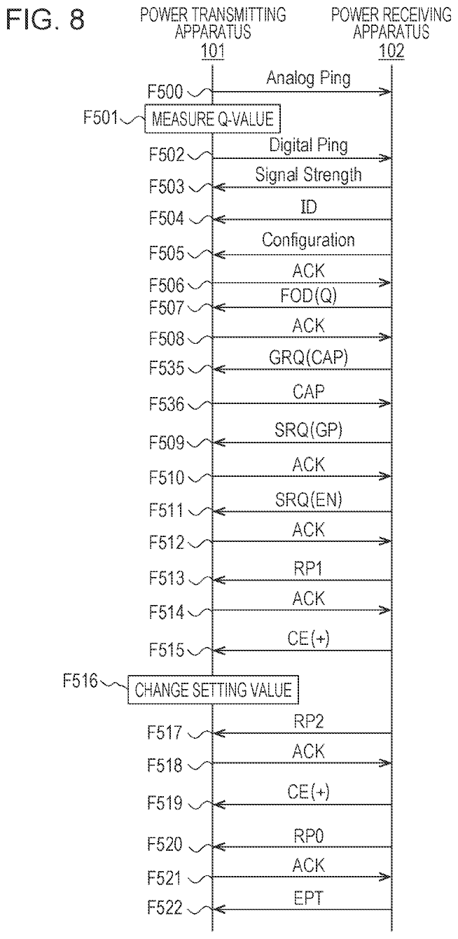

FIG. 8 is a diagram for describing processing performed by the power transmitting apparatus 101 and the power receiving apparatus 102 according to this embodiment. The power transmitting apparatus 101 and the power receiving apparatus 102 perform wireless power transmission compliant with the Wireless Power Consortium (WPC) standard. FIG. 8 is a sequence diagram illustrating a control flow of the power transmitting apparatus 101 and the power receiving apparatus 102 compliant with the WPC standard v1.2.3. The sequence illustrated in FIG. 8 is control executed not only by the power transmitting apparatus 101 including a plurality of power transmitting coils and a plurality of power transmitting units but also by a power transmitting apparatus having a configuration matching the WPC standard. In the following description, it is assumed that the power transmitting apparatus 101 transmits power to the power receiving apparatus 102 using a given power transmitting coil. Note that a case where the power transmitting apparatus 101 and the power receiving apparatus 102 are compliant with the WPC standard v1.2.3 will be described below, but the present disclosure is not limited to this. That is, the power transmitting apparatus 101 and the power receiving apparatus 102 may be compliant with a version of the WPC standard after the WPC standard v1.2.3, or may be compliant with a version earlier than the WPC standard v1.2.3.

The WPC standard defines a plurality of phases including a power transmission phase (Power Transfer phase) in which power transmission for charging is performed and a phase before power transmission for charging is performed. The phases before power transmission include (1) a Selection phase, (2) a Ping phase, (3) an Identification & Configuration phase, (4) a Negotiation phase, and (5) a Calibration phase. Hereinafter, the Identification & Configuration phase is referred to as I & C phase.

In the Selection phase, the power transmitting apparatus 101 transmits an Analog Ping (hereinafter, referred to as A-Ping) in order to detect an object that is present near the power transmitting coil (F500). Note that a method for controlling the A-Ping according to this embodiment will be described later. The A-Ping is a pulsed power for detecting an object. In addition, even if the power receiving apparatus 102 receives the A-Ping, the power is too small to activate the control unit 1021 of the power receiving apparatus 102. The power transmitting apparatus 101 intermittently transmits the A-Ping. The voltage or current applied to the power transmitting coil changes between a case where an object is placed in a power transmittable range of the power transmitting apparatus 101 and a case where no object is placed. Therefore, a control unit of the power transmitting apparatus 101 detects at least one of the voltage value and the current value of the power transmitting coil when the A-Ping is transmitted. The control unit of the power transmitting apparatus 101 determines that an object is present if the detected voltage value falls below a certain threshold value or if the detected current value exceeds a certain threshold value, and transitions to the Ping phase.

In the Ping phase, upon detecting placement of an object by the A-Ping, the power transmitting apparatus 101 measures a Q value (Quality Factor) of the power transmitting coil (F501). When the Q value measurement ends, the power transmitting apparatus 101 starts to transmit power of a Digital Ping (hereinafter, referred to as D-ping) (F502). The D-Ping is power for activating the control unit 1021 of the power receiving apparatus 102, and is larger than the A-Ping. After that, the power transmitting apparatus 101 continues to transmit power larger than or equal to the D-Ping after starting to transmit the power of the D-Ping (F502) until the power transmitting apparatus 101 receives an EPT (End Power Transfer) packet requesting a stop of power transmission from the power receiving apparatus 102 (F522). When activated by receiving the D-Ping, the control unit 1021 of the power receiving apparatus 102 transmits a Signal Strength packet, which is data storing the voltage value of the received D-Ping, to the power transmitting apparatus 101 (F503). The power transmitting apparatus 101 recognizes the object detected in the Selection phase as the power receiving apparatus 102 by receiving the Signal Strength packet from the power receiving apparatus 102 that has received the D-Ping. Upon receiving the Signal Strength packet, the power transmitting apparatus 101 transitions to the I & C phase.

In the I & C phase, the power receiving apparatus 102 transmits data storing an identifier (ID) including information of the version of the WPC standard with which the power receiving apparatus 102 complies and device identification information (F504). In addition, the power receiving apparatus 102 transmits, to the power transmitting apparatus 101, a Configuration packet including information indicating a maximum value of power to be supplied to a load by the power receiving unit 1025 (F505). By receiving the ID and the Configuration packet, the power transmitting apparatus 101 determines whether the power receiving apparatus 102 is a version corresponding to the WPC standard with which the power transmitting apparatus 101 complies, and transmits acknowledge (ACK). Specifically, if the power transmitting apparatus 101 determines that the power receiving apparatus 102 is compatible with an extended protocol of the WPC standard v1.2 or later (including processing in the Negotiation phase to be described later), the power transmitting apparatus 101 responds with the ACK (F506). Upon receiving the ACK, the power receiving apparatus 102 transitions to the Negotiation phase in which the power to be transmitted and received is negotiated.

In the Negotiation phase, the power receiving apparatus 102 transmits foreign object detection (FOD) Status data to the power transmitting apparatus 101 (F507). In this embodiment, the FOD Status data is referred to as FOD (Q). The power transmitting apparatus 101 performs foreign object detection based on a Q value stored in the received FOD (Q) and the Q value measured by the Q value measurement, and transmits, to the power receiving apparatus 102, an ACK indicating that it is determined that a foreign object is unlikely to be present (F508).

Upon receiving the ACK, the power receiving apparatus 102 transmits a General Request (Capability) packet, which is an inquiry about the capability of the power transmitting apparatus 101 and is one of the General Request packets defined by the WPC standard (F535). Hereinafter, the General Request (Capability) packet is referred to as GRQ (CAP) packet. Upon receiving the GRQ (CAP) packet, the power transmitting apparatus 101 transmits a Capability packet (hereinafter, referred to as CAP) storing capability information corresponding to the power transmitting apparatus 101 (F536).

The power receiving apparatus 102 negotiates a Guaranteed Power (hereinafter, referred to as GP), which is a maximum value of a power value requested to be received. Specifically, the Guaranteed Power represents the amount of power that can be used by the power receiving apparatus 102, which is agreed in the negotiation with the power transmitting apparatus 101. That is, the GP is the maximum value of power that can be used to be supplied to the load of the power receiving apparatus 102 (power to be consumed by the load). The negotiation is implemented by transmitting, to the power transmitting apparatus 101, a packet in which the value of the Guaranteed Power requested by the power receiving apparatus 102 is stored from among the Specific Request packets defined by the WPC standard (F509). In this embodiment, the data is referred to as SRQ (GP) packet.

The power transmitting apparatus 101 responds to the SRQ (GP) packet in consideration of, for example, the power transmission capability of the power transmitting apparatus 101. If it is determined that the Guaranteed Power can be accepted, the power transmitting apparatus 101 transmits an ACK indicating that the request has been accepted (F510). When the negotiation of a plurality of parameters including the Guaranteed Power ends, the power receiving apparatus 102 transmits, to the power transmitting apparatus 101, an SRQ (EN) packet to request the end of the negotiation (End Negotiation) from among the Specific Request packets (F511). The power transmitting apparatus 101 transmits an ACK in response to the SRQ (EN) packet (F512), ends the Negotiation phase, and transitions to the Calibration phase in which a reference for performing the foreign object detection based on a power loss method is created. Note that the foreign object detection is processing for determining whether an object different from the power receiving apparatus 102 (hereinafter, referred to as foreign object) is present, or whether there is a possibility that a foreign object is present, within the power transmittable range of the power transmitting apparatus 101.

In the Calibration phase, in a state in which the power receiving unit 1025 and the load (the battery 1026) are not connected to each other, the power receiving apparatus 102 notifies the power transmitting apparatus 101 of a received power value R1 when the power receiving apparatus 102 receives the D-Ping. At this time, the power receiving apparatus 102 transmits, to the power transmitting apparatus 101, a Received Power packet (model) (hereinafter, referred to as RP1) storing the received power value R1 (F513). Upon receiving the RP1, the power transmitting apparatus 101 transmits an ACK to the power receiving apparatus 102 (F514). At this time, the power transmitting apparatus 101 measures a transmitted power value T1 of the power transmitting apparatus 101, and calculates a difference A1 between T1 and R1, which is a power loss.

After receiving the ACK, the power receiving apparatus 102 transmits, to the power transmitting apparatus 101, a Control Error packet (hereinafter, referred to as CE) to request the power transmitting apparatus 101 to increase or decrease a received power voltage, in a state in which the power receiving unit 1025 and the load are connected to each other. A sign and a numerical value are stored in the CE. If the sign of the numerical value stored in the CE is plus, it means that the received power voltage is requested to be increased. If the sign is minus, it means that the received power voltage is requested to be decreased. If the numerical value is zero, it means that the received power voltage is requested to be maintained. Here, the power receiving apparatus 102 transmits, to the power transmitting apparatus 101, a CE (+) indicating that the received power voltage is to be increased (F515).

Upon receiving the CE (+), the power transmitting apparatus 101 changes a setting value of a power transmitting unit and increases a transmitted power voltage (F516). When the received power increases in response to the CE (+), the power receiving apparatus 102 supplies the received power to the load and transmits a Received Power packet (model) (hereinafter, referred to as RP2) to the power transmitting apparatus 101 (F517). Here, the RP2 stores a received power value R2 in a state in which the power receiving apparatus 102 supplies the output of the power receiving unit 1025 to the load (the battery 1026).

Upon receiving the RP2, the power transmitting apparatus 101 transmits an ACK to the power receiving apparatus 102 (F518). At this time, the power transmitting apparatus 101 measures a transmitted power value T2 of the power transmitting apparatus 101, and calculates a difference A2 between T2 and R2, which is a power loss. The power transmitting apparatus 101 performs the foreign object detection based on the power losses with reference to the power loss Δ1, in a case where the power receiving unit 1025 is not connected to the load and the power consumption of the load is zero, and the power loss Δ2, in a case where the power receiving unit 1025 is connected to the load and the power consumption of the load is not zero. Specifically, the power transmitting apparatus 101 can predict a power loss in a state in which a foreign object is not present at a given received power value based on Δ1 and Δ2, and perform the foreign object detection based on the received power value actually received and the transmitted power value. Upon transmitting the ACK in response to the RP2, the power transmitting apparatus 101 transitions to the Power Transfer phase.

In the Power Transfer phase, the power transmitting apparatus 101 transmits power with which the power receiving apparatus 102 can receive a maximum of 15 watts negotiated in the Negotiation phase. The power receiving apparatus 102 transmits, to the power transmitting apparatus 101, a Received Power packet (mode0) (hereinafter, referred to as RP0), in which the CE and the current received power value are stored, on a regular basis (F519, F520). Upon receiving the RP0 from the power receiving apparatus 102, the power transmitting apparatus 101 predicts a power loss at a given received power based on Δ1 and Δ2 above, and performs the foreign object detection. If it is determined that a foreign object is unlikely to be present as a result of the foreign object detection, the power transmitting apparatus 101 transmits an ACK to the power receiving apparatus 102 (F521). If it is determined that a foreign object is likely to be present, the power transmitting apparatus 101 transmits non-acknowledge (NAK) to the power receiving apparatus 102.

When the charging of the battery 1026 ends, the power receiving apparatus 102 transmits, to the power transmitting apparatus 101, the EPT (End Power Transfer) packet requesting a stop of the power transmission (F522). The control flow of the power transmitting apparatus 101 and the power receiving apparatus 102 compliant with the WPC standard v1.2.3 is as described above.

FIG. 4 is a diagram illustrating a configuration example of the load modulation signal modulating unit 1024 in FIG. 2. The load modulation signal modulating unit 1024 includes switches 4011, 4012, 4013, 4014, and 4015 and capacitors 4021, 4022, 4023, 4024, and 4025.

The load modulation signal modulating unit 1024 changes the degree of modulation of the load modulation signal 103 in FIG. 1. The capacitors 4021, 4022, 4023, 4024, and 4025 are connected to the power receiving antenna 1023 in FIG. 2 by closing the switches 4011, 4012, 4013, 4014, and 4015, respectively. The switches 4011, 4012, 4013, 4014, and 4015 can change the degree of modulation of the load modulation signal 103 in FIG. 1 by repeating opening and closing of any one or more of the switches. The capacitances of the connected capacitors 4021 to 4025 may be the same or different. This is because the total capacitance changes as a result of the number of opened/closed switches 4011 to 4015. For example, in a case where the capacitors 4021 to 4025 have the same capacitance, when a larger number of switches 4011 to 4015 are turned on, the capacitance of the load modulation signal modulating unit 1024 increases, and thus the degree of modulation increases. In addition, in a case where the capacitors 4021 to 4025 are capacitors having different capacitances, by switching the switch to be turned on and switching to a capacitor having a larger capacitance, the degree of modulation can be increased.

Although FIG. 4 illustrates an example in which the degree of modulation of the load modulation signal 103 is changed by the connection state of the capacitors 4021 to 4025, the degree of modulation can also be changed by resistors, coils, or a combination thereof. Although the capacitors 4021 to 4025 are connected in parallel in FIG. 4, the degree of modulation can be changed even in a circuit configuration in which the capacitors are connected in series and a switch is arranged to bypass each capacitor. Note that it is assumed in this embodiment that the degree of modulation increases as the capacitance of the load modulation signal modulating unit 1024 increases. However, depending on conditions such as the magnitude of received power, the degree of modulation may be increased by reducing the capacitance. In this case, the power receiving apparatus 102 switches the switch so that the capacitance of the load modulation signal modulating unit 1024 is reduced.

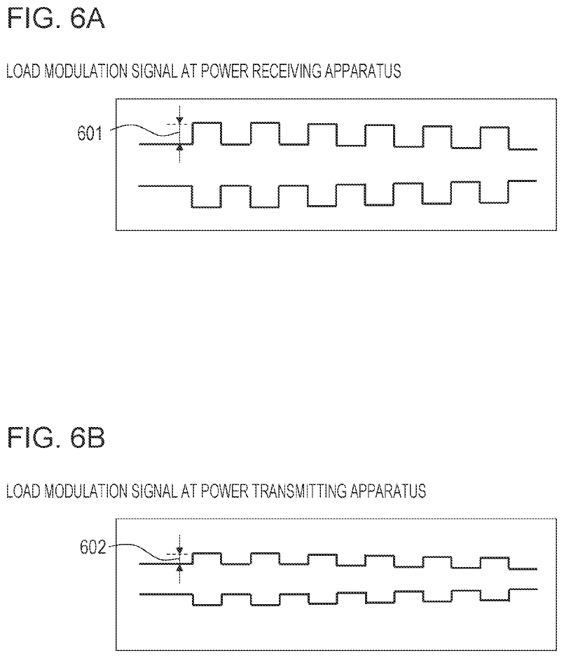

FIG. 6A is a diagram illustrating an amplitude 601 of the load modulation signal 103 transmitted by the power receiving apparatus 102. FIG. 6B is a diagram illustrating an amplitude 602 of the load modulation signal 103 received by the power transmitting apparatus 101.

FIG. 6A illustrates the amplitude 601 of the load modulation signal 103 transmitted by the power receiving apparatus 102. Subsequently, when a foreign object or the like is nearby during power transmission, the amplitude of the load modulation signal 103 changes. Due to the influence of the foreign object, the amplitude 602 of the load modulation signal 103 received by the power transmitting apparatus 101 is smaller than the amplitude 601 as illustrated in FIG. 6B. If the amplitude 602 decreases to a level at which demodulation is difficult, the amplitude 602 is not different from a fluctuating noise to the power transmitting apparatus 101.

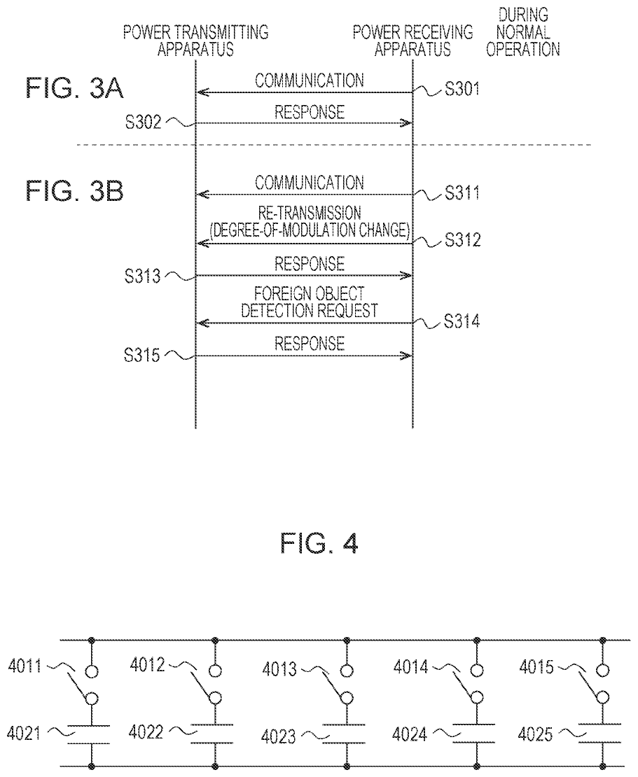

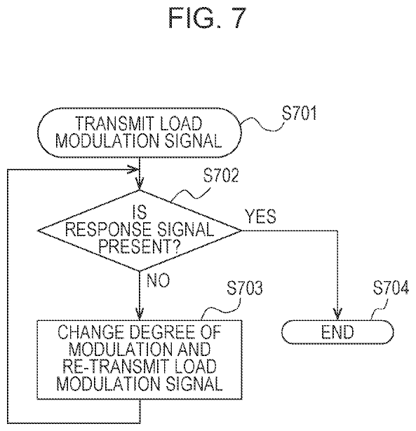

FIG. 3A is a diagram illustrating a communication flow example between the power transmitting apparatus 101 and the power receiving apparatus 102 during normal operation. FIG. 3B is a diagram illustrating a communication flow example between the power transmitting apparatus 101 and the power receiving apparatus 102 in a case where a foreign object is placed in the power transmission range of the power transmitting apparatus 101. FIG. 7 is a flowchart illustrating a method for controlling the power receiving apparatus 102. The process illustrated in FIG. 7 is performed by the control unit 1021 executing the control program stored in a memory (not illustrated).

The following description will be given with reference to FIGS. 3A, 3B, and 7. At the start of power transmission, the power receiving apparatus 102 performs amplitude modulation of the load modulation signal 103 by repeatedly opening and closing only the switch 4011 of the load modulation signal modulating unit 1024. The “communication” in FIGS. 3A and 3B is, for example, the RP0 transmitted from the power receiving apparatus 102 to the power transmitting apparatus 101 in the power transmission phase. However, the communication is not limited to this. This embodiment is applicable to any communication in which a response is transmitted from the power transmitting apparatus 101.

FIG. 3A is a diagram illustrating a communication flow example between the power transmitting apparatus 101 and the power receiving apparatus 102 during normal operation. During normal operation, as illustrated in FIG. 3A, in step S701, the control unit 1021 of the power receiving apparatus 102 transmits the load modulation signal 103 to the power transmitting apparatus 101 by load modulation using the load modulation signal modulating unit 1024 (S301). Upon receiving the load modulation signal 103, the power transmitting apparatus 101 transmits a response signal to the power receiving apparatus 102 (S302). In step S702, the control unit 1021 of the power receiving apparatus 102 determines whether the response signal has been received by the communication receiving unit 1022, and if it is determined that the response signal has been received, the process proceeds to step S704. In step S704, the control unit 1021 of the power receiving apparatus 102 ends the process for the load modulation signal 103.

FIG. 3B is a diagram illustrating a communication flow example between the power transmitting apparatus 101 and the power receiving apparatus 102 in a case where a foreign object is placed in the power transmission range of the power transmitting apparatus 101. For example, if the amplitude 602 of the load modulation signal 103 decreases due to placement of a foreign object in the power transmission range of the power transmitting apparatus 101, the power transmitting apparatus 101 is unable to demodulate the load modulation signal 103 from the power receiving apparatus 102 and determines that the load modulation signal 103 is not transmitted. As a result, the power transmitting apparatus 101 is unable to transmit a response signal. This is illustrated in FIG. 3B.

The flow in FIG. 3B will be described with reference to the flowchart in FIG. 7. In step S701, the control unit 1021 of the power receiving apparatus 102 transmits the load modulation signal 103 to the power transmitting apparatus 101 by load modulation using the load modulation signal modulating unit 1024 (S311). If the amplitude 602 of the load modulation signal 103 decreases due to placement of a foreign object in the power transmission range of the power transmitting apparatus 101, the power transmitting apparatus 101 is unable to demodulate the load modulation signal 103 from the power receiving apparatus 102, and thus does not transmit a response signal.

In step S702, the control unit 1021 of the power receiving apparatus 102 determines whether the response signal has been received by the communication receiving unit 1022 within a predetermined period, and if the response signal is not received, the process proceeds to step S703. In step S703, the control unit 1021 repeatedly opens and closes the switch 4011 and the switch 4012 of the load modulation signal modulating unit 1024 at the same time to change the degree of modulation to be increased, and retransmits the load modulation signal 103 to the power transmitting apparatus 101 with the changed degree of modulation (S312). Note that at this time, since the power transmitting apparatus 101 determines that the load modulation signal 103 is not transmitted from the power receiving apparatus 102, the power transmission processing times out when a certain time (timeout time) elapses, and power transmission to the power receiving apparatus 102 is stopped. Therefore, before an elapse of the timeout time for stopping power transmission from the power transmitting apparatus 101, the power receiving apparatus 102 changes the degree of modulation and performs re-transmission, and the process returns to step S702.

Since the amplitude of the load modulation signal 103 transmitted with the changed degree of modulation is large, the power transmitting apparatus 101 can demodulate the load modulation signal 103 and transmits a response signal to the power receiving apparatus 102 (S313). In step S702, the control unit 1021 of the power receiving apparatus 102 determines that the communication receiving unit 1022 has received the response signal within the predetermined period. Since the reception succeeds after the change in the degree of modulation, the control unit 1021 of the power receiving apparatus 102 determines that there is a possibility that a foreign object is present nearby, and transmits a foreign object detection request to the power transmitting apparatus 101 (S314).

Upon receiving the foreign object detection request, the power transmitting apparatus 101 transmits a response signal to the power receiving apparatus 102 (S315), interrupts power transmission as necessary, and performs foreign object detection. The foreign object detection request may be a request packet or may be the RP0. If the foreign object detection request is transmitted as the request packet from the power receiving apparatus 102, the power transmitting apparatus 101 can perform the foreign object detection processing using any given method. If the foreign object detection request is transmitted as the RP0 from the power receiving apparatus 102, the power transmitting apparatus 101 can perform the foreign object detection based on a power loss by comparing the amount of power transmitted by the power transmitting apparatus 101 with the amount of power received by the power receiving apparatus 102.

As described above, the power receiving unit 1025 wirelessly receives power from the power transmitting apparatus 101. In step S701, the control unit 1021 functions as a transmission unit, and transmits, to the power transmitting apparatus 101, the load modulation signal 103 superimposed on the power. In step S703, if the response signal is not obtained from the power transmitting apparatus 101 within the predetermined period after the transmission of the load modulation signal 103, the control unit 1021 causes the load modulation signal modulating unit 1024 to change (increase) the degree of modulation of the load modulation signal 103. Specifically, in step S703, if the response signal is not obtained from the power transmitting apparatus 101 within the predetermined period after the transmission of the load modulation signal 103, the control unit 1021 causes the load modulation signal modulating unit 1024 to change the degree of modulation of the load modulation signal 103 and transmit the load modulation signal 103. The degree of modulation of the load modulation signal 103 is expressed based on, for example, the difference between the maximum value (high level) and the minimum value (low level) of the load modulation signal 103 as illustrated in FIG. 6A and FIG. 6B. The response signal may be, for example, the frequency-modulated signal 104.

If the load modulation signal (S312) transmitted by the power receiving apparatus 102 is detected, the power transmitting apparatus 101 superimposes the response signal (S313) on the power and transmits the signal to the power receiving apparatus 102. If the response signal (S313) is obtained from the power transmitting apparatus 101 after the re-transmission of the load modulation signal 103, the control unit 1021 causes the load modulation signal modulating unit 1024 to superimpose the signal (S314) to request the foreign object detection on the power and transmit the signal to the power transmitting apparatus 101.

As described above, according to this embodiment, if the response signal is not obtained from the power transmitting apparatus 101, the power receiving apparatus 102 increases the degree of modulation and re-transmits the load modulation signal 103 to the power transmitting apparatus 101. Thus, the power receiving apparatus 102 can more reliably transmit the load modulation signal 103 to the power transmitting apparatus 101, and can detect the possibility of the presence of a foreign object and transmit a request for the foreign object detection processing to the power transmitting apparatus 101. Note that since the power receiving apparatus 102 can set the degree of modulation to a given degree before the power transmission phase, the initial degree of modulation may be set to a relatively large degree. However, as in this embodiment, there is an effect that the power receiving apparatus 102 can detect the possibility of the presence of a foreign object by changing the degree of modulation if the response signal is not obtained from the power transmitting apparatus 101. In addition, as the degree of modulation increases, noise during normal communication may also increase. Therefore, there is an effect that noise during communication is suppressed by the power receiving apparatus 102 performing communication from a state in which the degree of modulation is relatively small.

### Second Embodiment

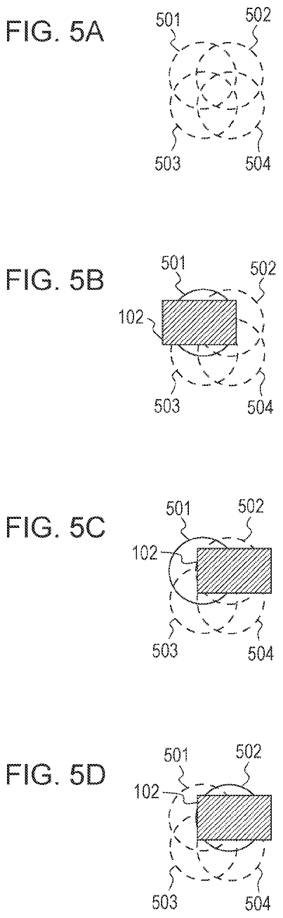

FIG. 5A is a diagram illustrating a configuration example of power transmitting coils 501 to 504 of the power transmitting apparatus 101 according to a second embodiment. A case where the power transmitting apparatus 101 includes the plurality of power transmitting coils 501 to 504 will be described. The plurality of power transmitting coils 501 to 504 are a plurality of coils. The power transmitting coil 501, the power transmitting coil 502, the power transmitting coil 503, and the power transmitting coil 504 overlap each other.

FIGS. 5B to 5D are diagrams illustrating a case where the power receiving apparatus 102 has moved relative to the power transmitting coils 501 to 504 of the power transmitting apparatus 101. The power receiving apparatus 102 moves due to an impact, for example. Among the power transmitting coils 501 to 504, the power transmitting coils indicated by broken lines are power transmitting coils that are not performing power transmission, and the power transmitting coils indicated by solid lines are power transmitting coils that are performing power transmission.

FIG. 5B indicates a state in which the power receiving apparatus 102 is placed on the power transmitting coil 501 and power transmission from the power transmitting coil 501 to the power receiving apparatus 102 is started. The power transmitting coil 501 is used for power transmission.

FIG. 5C illustrates a state in which the power receiving apparatus 102 is displaced due to an impact or the like during power transmission in FIG. 5B. The power receiving apparatus 102 is almost deviated from the power transmitting coil 501 that is performing power transmission. Therefore, as illustrated in FIG. 6B, the amplitude 602 of the load modulation signal 103 received by the power transmitting apparatus 101 from the power receiving apparatus 102 decreases, and the power transmitting apparatus 101 is unable to demodulate the load modulation signal 103 and is unable to transmit a response signal.

If the communication receiving unit 1022 does not receive the response signal in step S702, the control unit 1021 of the power receiving apparatus 102 proceeds to step S703. In step S703, the control unit 1021 repeatedly opens and closes the switch 4011 and the switch 4012 at the same time to change the degree of modulation to be increased, and retransmits the load modulation signal 103 to the power transmitting apparatus 101 with the changed degree of modulation (S312), and the process returns to step S702.

Since the amplitude of the load modulation signal 103 transmitted with the changed degree of modulation is large, the power transmitting apparatus 101 can demodulate the load modulation signal 103 and transmits a response signal to the power receiving apparatus 102 (S313). In step S702, the control unit 1021 of the power receiving apparatus 102 determines that the communication receiving unit 1022 has received the response signal within the predetermined period. Since the reception succeeds after the change in the degree of modulation, the control unit 1021 of the power receiving apparatus 102 determines that the power receiving apparatus 102 is displaced, and transmits a position detection request for the power receiving apparatus 102 to the power transmitting apparatus 101 (S314).

Upon receiving the position detection request for the power receiving apparatus 102, the power transmitting apparatus 101 transmits a response signal to the position detection request to the power receiving apparatus 102 (S315), stops power transmission, and detects the position of the power receiving apparatus 102. Upon detecting the movement of the power receiving apparatus 102 to the position of the power transmitting coil 502 as a result of the detection, the power transmitting apparatus 101 starts power transmission by using the power transmitting coil 502, as illustrated in FIG. 5D. After the power transmitting apparatus 101 detects the position, the power receiving apparatus 102 may decrease the degree of modulation by the load modulation signal modulating unit 1024 as necessary.

In the above manner, if the response signal (S313) is obtained from the power transmitting apparatus 101 after the re-transmission of the load modulation signal (S312), the control unit 1021 causes the load modulation signal modulating unit 1024 to superimpose the position detection request on the power and transmit the request to the power transmitting apparatus 101. The position detection request is a signal to request power transmission corresponding to the position of the power receiving apparatus 102.

Upon receiving the position detection request, the power transmitting apparatus 101 detects the position of the power receiving apparatus 102, and wirelessly transmits power using a power transmitting coil corresponding to the detected position of the power receiving apparatus 102. The power transmitting coil is one or more of the plurality of power transmitting coils 501 to 504 or a moving coil, which is a movable power transmitting coil.

Note that after the start of power transmission corresponding to the position of the power receiving apparatus 102, the control unit 1021 may cause the load modulation signal modulating unit 1024 to decrease the degree of modulation of the load modulation signal 103.

As described above, according to this embodiment, the power transmitting apparatus 101 can detect the position of the power receiving apparatus 102 and correct the displacement of the power receiving apparatus 102 relative to the power transmitting coil.

The power receiving apparatus 102 changes the degree of modulation of the load modulation signal 103, so that the power receiving apparatus 102 can maintain communication with the power transmitting apparatus 101. If the power transmitting apparatus 101 includes one or more of a plurality of coils or a moving coil, it is possible to determine that the situation in which the load modulation signal is unable to be communicated is due to displacement of the power receiving apparatus 102. The power receiving apparatus 102 can retransmit the load modulation signal 103 with the changed degree of modulation and transmit the position detection request to the power transmitting apparatus 101. If the load modulation signal 103 is in a communicable state, the power receiving apparatus 102 can transmit the foreign object detection request to the power transmitting apparatus 101.

Note that in the first and second embodiments, if the power receiving apparatus 102 does not obtain a response signal from the power transmitting apparatus 101 within the predetermined period after the transmission of the load modulation signal 103 in step S702, the power receiving apparatus 102 determines that the power transmitting apparatus 101 is unable to demodulate the load modulation signal 103 because the amplitude of the load modulation signal 103 is small. Subsequently, the power receiving apparatus 102 causes the load modulation signal modulating unit 1024 to change (increase) the degree of modulation of the load modulation signal 103. However, the present disclosure is not limited to this configuration. Based on the voltage value or the current value of the power receiving antenna, the power receiving apparatus 102 may observe the amplitude 601 of the load modulation signal 103 illustrated in FIG. 6A and may predict the amplitude 602 of the load modulation signal 103 in the power transmitting apparatus 101. Subsequently, the power receiving apparatus 102 compares the predicted value of the amplitude 602 with a threshold value of the amplitude 602 with which the power transmitting apparatus 101 can demodulate the load modulation signal 103, and changes (increases) the degree of modulation of the load modulation signal 103 if the predicted value is smaller than or equal to the threshold value (or close to the threshold value). Also with this configuration, the same effects as those of the first and second embodiments can be obtained.

The power receiving apparatus 102 may also predict the amplitude 602 on the power transmitting apparatus 101 side from a coupling coefficient between a power transmitting antenna (not illustrated) included in the power transmitting apparatus 101 and the power receiving antenna 1023 or power consumption of a load (e.g., a charging circuit of the battery 1026) of the power receiving apparatus 102.

In the first and second embodiments, the power receiving apparatus 102 is configured to change the degree of modulation of the load modulation signal modulating unit 1024 of the power receiving apparatus 102. However, this configuration can also be applied to the power transmitting apparatus 101. That is, the power transmitting apparatus 101 may be configured to change the degree of modulation of the frequency-modulated signal 104 of the power transmitting apparatus 101. Specifically, if the power transmitting apparatus 101 is unable to receive an expected response from the power receiving apparatus 102 in response to the transmitted frequency-modulated signal 104, the power transmitting apparatus 101 may change (increase) the degree of modulation of frequency modulation and transmit the frequency-modulated signal 104 again. With such a structure, there is an effect that the frequency-modulated signal 104 can be demodulated if the power transmitting apparatus 101 determines that the power receiving apparatus 102 is unable to demodulate the frequency-modulated signal 104 due to a foreign object or the like.

The power transmitting apparatus 101 may determine whether the demodulation is possible by observing the frequency-modulated signal 104 based on the voltage value or the current value of the power transmitting antenna and predicting the modulation depth of the frequency-modulated signal in the power receiving apparatus 102. Subsequently, the power transmitting apparatus 101 compares the predicted value of the modulation depth with a threshold value of the modulation depth with which the power receiving apparatus 102 can demodulate the frequency-modulated signal, and changes (increases) the degree of modulation of the frequency-modulated signal 104 if the predicted value is smaller than or equal to the threshold value (or close to the threshold value). Also with this configuration, the same effect can be obtained.

The modulation depth on the power receiving apparatus 102 side may also be predicted from a coupling coefficient between a power transmitting antenna (not illustrated) of the power transmitting apparatus 101 and the power receiving antenna 1023 or power consumption of a load (e.g., a charging circuit of the battery 1026) of the power receiving apparatus 102.

Furthermore, although the power transmitting apparatus 101 is configured to transmit the frequency-modulated signal 104 in the above-described embodiments, this may be an amplitude-modulated signal. Specifically, if the power transmitting apparatus 101 is unable to receive an expected response from the power receiving apparatus 102 in response to the transmitted amplitude-modulated signal, the power transmitting apparatus 101 may change (increase) the degree of modulation of amplitude modulation and transmit the amplitude-modulated signal again. With such a structure, there is an effect that the amplitude-modulated signal can be demodulated if the power transmitting apparatus 101 determines that the power receiving apparatus 102 is unable to demodulate the amplitude-modulated signal due to a foreign object or the like.

In the above determination, based on the voltage value or the current value of the power transmitting antenna, the power transmitting apparatus 101 may observe the amplitude-modulated signal and may predict the modulation depth of the amplitude-modulated signal in the power receiving apparatus 102. Subsequently, the power transmitting apparatus 101 compares the prediction of the modulation depth with a threshold value of the modulation depth with which the power receiving apparatus 102 can demodulate the amplitude-modulated signal, and changes (increases) the degree of modulation of the amplitude-modulated signal if the prediction is smaller than or equal to the threshold value (or close to the threshold value). In this manner, the same effect can also be obtained.

The modulation depth on the power receiving apparatus 102 side may also be predicted from a coupling coefficient between a power transmitting antenna (not illustrated) of the power transmitting apparatus 101 and the power receiving antenna 1023 or power consumption of a load (e.g., a charging circuit of the battery 1026) of the power receiving apparatus 102. The power consumption of the load may be based on the received power value of which the power receiving apparatus 102 notifies the power transmitting apparatus 101.

It should be noted that each of the above-described embodiments is merely a specific example for carrying out the present disclosure, and the technical scope of the present disclosure is not interpreted in a limited manner by these embodiments. That is, the present disclosure can be implemented in various forms without departing from the technical idea or the main features thereof.

### OTHER EMBODIMENTS

The above-described first and second embodiments may be implemented in combination.

The power receiving apparatus and the power transmitting apparatus can have a function of executing an application other than wireless charging. An example of the power receiving apparatus is an information processing terminal such as a smartphone, and an example of the power transmitting apparatus is an accessory device for charging the information processing terminal. For example, the information processing terminal includes a display unit (display) that displays information to a user and that is supplied with power received from a power receiving coil (antenna). The power received from the power receiving coil is stored in a power storage unit (battery), and the power is supplied from the battery to the display unit. In this case, the power receiving apparatus may include a communication unit for communicating with another apparatus different from the power transmitting apparatus. The communication unit may be compatible with a communication standard such as near field communication (NFC) or the fifth generation mobile communication system (5G). Furthermore, in this case, the communication unit may perform communication by power being supplied from the battery to the communication unit. The power receiving apparatus may be a tablet terminal, a storage device such as a hard disk device or a memory device, or an information processing apparatus such as a personal computer (PC). Furthermore, the power receiving apparatus may be, for example, an imaging apparatus (a camera, a video camera, or the like). The power receiving apparatus may be an image input apparatus such as a scanner or an image output apparatus such as a printer, a copier, or a projector. The power receiving apparatus may be a robot, a medical device, or the like. The power transmitting apparatus can be an apparatus for charging the above-described device.

The power transmitting apparatus may be a smartphone. In this case, the power receiving apparatus may be another smartphone or wireless earphones.

The power receiving apparatus according to any of the above embodiments may be a vehicle such as an automobile or an automated guided vehicle (AGV). For example, an automobile serving as the power receiving apparatus may receive power from a charger (power transmitting apparatus) via a power transmitting antenna installed in a parking lot. The vehicle serving as the power receiving apparatus may receive power from a charger (power transmitting apparatus) via a power transmitting coil (antenna) embedded in a road or a traveling path. In such a vehicle, the received power is supplied to the battery. The power of the battery may be supplied to an actuation unit (a motor or an electric-powered unit) that drives the wheels, or may be used to drive a sensor used for driving assistance or to drive a communication unit that performs communication with an external apparatus. That is, in this case, the power receiving apparatus may include, in addition to the wheels, a battery, a motor and a sensor that are driven using the received power, and a communication unit that communicates with an apparatus other than the power transmitting apparatus. The power receiving apparatus may further include an accommodation unit for accommodating people. For example, the sensor may be a sensor used to measure an inter-vehicle distance or a distance to another obstacle. The communication unit may be compatible with, for example, a global position system (Global Positioning Satellite, GPS). The communication unit may also be compatible with a communication standard such as the fifth generation mobile communication system (5G). In addition, the vehicle may be a bicycle or a motorcycle. Furthermore, the power receiving apparatus is not limited to a vehicle, and may be a moving object, a flying object, or the like having an actuation unit that is driven using power stored in a battery.

The power receiving apparatus according to any of the above embodiments may be an electric tool, a home electric appliance, or the like. These devices, which are power receiving apparatuses, may include, in addition to a battery, a motor that is driven by received power stored in the battery. In addition, these devices may include a notification unit for providing a notification of the remaining amount of the battery or the like. These devices may include a communication unit for communicating with another apparatus different from the power transmitting apparatus. The communication unit may also be compatible with a communication standard such as NFC or the fifth generation mobile communication system (5G).

The power transmitting apparatus according to any of the above embodiments may be an in-vehicle charger that transmits power to a mobile information terminal device such as a smartphone or a tablet compatible with wireless power transmission in an automobile. Such an in-vehicle charger may be provided anywhere in the automobile. For example, the in-vehicle charger may be installed in a console of the automobile, or may be installed in an instrument panel (dashboard), between passenger seats, on the ceiling, or on a door. However, it is preferably installed in a place so as not to interfere with the driving. In addition, although an example in which the power transmitting apparatus is an in-vehicle charger has been described, such a charger is not limited to being disposed in a vehicle, and may be installed in a transport vehicle such as a train, an aircraft, or a ship. In this case, the charger may also be installed between passenger seats, on the ceiling, or on a door.

In addition, a vehicle such as an automobile including an in-vehicle charger may be the power transmitting apparatus. In this case, the power transmitting apparatus includes wheels and a battery, and supplies power to the power receiving apparatus via a power transmitting circuit unit or a power transmitting coil (antenna) using power from the battery.

The present disclosure can also be implemented by processing in which a program for implementing one or more functions in the above-described embodiments is supplied to a system or an apparatus via a network or a storage medium, and one or more processors in a computer of the system or the apparatus read and execute the program. In addition, the present disclosure can also be implemented by a circuit (e.g., an ASIC) that implements one or more functions.

The present disclosure is not limited to the above-described embodiments, and various changes and modifications can be made without departing from the spirit and scope of the present disclosure. Accordingly, the following claims are appended to disclose the scope of the present disclosure.

1. A power receiving apparatus comprising:
a power receiving unit configured to wirelessly receive power from a power transmitting apparatus; and
a communication unit configured to communicate with the power transmitting apparatus by load modulation of the received power, a degree of modulation of the load modulation by the communication unit being changed in a case where a response signal from the power transmitting apparatus in response to a specific signal transmitted by the communication unit is not received within a period.

2. The power receiving apparatus according to claim 1, wherein, in a case where the response signal is not received within the period, the degree of modulation of the load modulation is increased.

3. The power receiving apparatus according to claim 1, wherein, in a case where the response signal is not received within the period, the communication unit transmits a specific signal subjected to the load modulation based on the changed degree of modulation.

4. The power receiving apparatus according to claim 1, wherein the degree of modulation is represented based on a difference between a maximum value and a minimum value of an amplitude of the specific signal subjected to the load modulation.

5. The power receiving apparatus according to claim 3, wherein, in a case where the communication unit receives the response signal from the power transmitting apparatus in response to a specific signal subjected to the load modulation based on the changed degree of modulation, the communication unit transmits, to the power transmitting apparatus, a signal to request detection processing for detecting of a foreign object.

6. The power receiving apparatus according to claim 1, wherein, in a case where the communication unit receives the response signal from the power transmitting apparatus in response to a specific signal subjected to the load modulation based on the changed degree of modulation, the communication unit transmits, to the power transmitting apparatus, a signal to request power transmission corresponding to a position of the power receiving apparatus.

7. The power receiving apparatus according to claim 6, wherein, after the communication unit transmits the signal to request power transmission corresponding to the position of the power receiving apparatus, the degree of modulation of the load modulation is decreased.

8. The power receiving apparatus according to claim 1, wherein the communication unit receives a frequency-modulated signal as the response signal.

9. The power receiving apparatus according to claim 1, further comprising:
a battery configured to store the power received by the power receiving unit; and
a motor configured to drive a wheel using the power from the battery.

10. The power receiving apparatus according to claim 1, further comprising:
a battery configured to store the power received by the power receiving unit; and
a display unit configured to receive the power from the battery.

11. The power receiving apparatus according to claim 1, further comprising:
a battery configured to store the power received by the power receiving unit; and
a notification unit for providing a notification of a remaining amount of the battery.

12. A communication method for a power receiving apparatus, comprising:
wirelessly receiving power from a power transmitting apparatus; and
transmitting a specific signal to the power transmitting apparatus by load modulation of the received power,
wherein a degree of modulation of the load modulation is changed in a case where a response signal from the power transmitting apparatus in response to the specific signal is not received within a period.

13. A non-transitory computer-readable storage medium storing a program for causing a computer to execute a communication method for a power receiving apparatus, comprising:
wirelessly receiving power from a power transmitting apparatus; and
transmitting a specific signal to the power transmitting apparatus by load modulation of the received power,
wherein a degree of modulation of the load modulation is changed in a case where a response signal from the power transmitting apparatus in response to the specific signal is not received within a period.
